(19) United States
(12) Patent Application Publication
(10) Pub. No.: US 2008/0189881 A1
(43) Pub. Date: Aug. 14, 2008

(54) Mixtures of Red Vat Dyes, Method for the Production Thereof and Their Use for Dying Material Containing Hydroxy Groups

(75) Inventors: Gunther Widler, Grosskarlbach (DE); Udo Arenz, Kelkheim (DE); Stefan Meier, Frankfurt (DE); Claus Marschner, Speyer (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 11/914,145

(22) PCT Filed: Jun. 6, 2006
(86) PCT No.: PCT/EP2006/062932

§ 371 Date: Nov. 12, 2007

(30) Foreign Application Priority Data
Jun. 9, 2005 (DE) 10 2005 026 454.9

(51) Int. Cl. C09B 67/28

(52) U.S. Cl. 8/638

(57) ABSTRACT

The present invention relates to dye mixtures comprising the dye C.I. Vat Red 13 and at least one dye selected from the group consisting of C.I. Vat Red 1, C.I. Vat Red 10, C.I. Vat Red 14, C.I. Vat Red 15, C.I. Vat Red 23 and C.I. Vat Red 32, their production and their use for dyeing and printing hydroxyl-containing materials.

Commercially available vat dyes for red shades possess certain performance defects, for example an insufficient build-up or a more or less pronounced shift in hue on soaping in textile-dyeing and -finishing facilities and at the consumer's.

Consequently, there is a need for novel products for producing red shades that overcome these disadvantages. It has now been found that, surprisingly, dye mixtures comprising C.I. Vat Red 13 and C.I. Vat Red 1, C.I. Vat Red 10, C.I. Vat Red 14, C.I. Vat Red 15, C.I. Vat Red 23 and/or Red 32 exhibit not only an unexpected synergy in build-up, i.e., a build-up distinctly above the arithmetic mean of the individual components, but also excellent stability in hue after soaping.

The dyes mentioned are known from the Colour Index and are commercially available as individual dyes. The literature also describes various dyeing processes utilizing these dyes, see for example WO00/32333 and WO03/016614.

The present invention accordingly provides dye mixtures comprising the dye C.I. Vat Red 13 and at least one dye selected from the group consisting of C.I. Vat Red 1, C.I. Vat Red 10, C.I. Vat Red 14, C.I. Vat Red 15, C.I. Vat Red 23 and C.I. Vat Red 32.

Preferred dye mixtures comprise C.I. Vat Red 13 and C.I. Vat Red 23.

Preferred dye mixtures are also those comprise from 5% to 95% by weight of C.I. Vat Red 13 and from 95% to 5% by weight of at least one dye selected from the group consisting of C.I. Vat Red 1, C.I. Vat Red 10, C.I. Vat Red 14, C.I. Vat Red 15, C.I. Vat Red 23 and C.I. Vat Red 32.

Particularly preferred dye mixtures of the present invention comprise from 10% to 50% by weight of C.I. Vat Red 13 and from 50% to 90% by weight of at least one dye selected from the group consisting of C.I. Vat Red 1, C.l. Vat Red 10, C.I. Vat Red 14, C.I. Vat Red 15, C.I. Vat Red 23 and C.I. Vat Red 32. Very particularly preferred dye mixtures comprising from 20% to 30% by weight of C.I. Vat Red 13 and from 80% to 70% by weight of C.I. Vat Red 23.

The dye mixtures of the present invention can be a preparation in solid or liquid form. In solid form, they include, to the extent necessary, the auxiliaries (dispersants, dustproofers, for example) and shading dyes customary in commercial dyes. In liquid form (inclusive of the presence of the thickeners of the type customary in print pastes), they may also include substances which ensure a long life for these preparations, examples being agents preventing fungal/bacterial infestation.

In solid form, the dye mixtures of the present invention are typically present as a powder or granulation (hereinafter referred to in general as a preparation) with or without one or more of the abovementioned auxiliaries. In the preparations, the dye mixture is preferably present at 20% to 90% by weight, based on the preparation.

When the dye mixtures of the present invention are present in an aqueous solution, the total dye content in these aqueous solutions is normally up to about 50% by weight, for example between 5% and 50% by weight.

The dye mixtures of the present invention are obtainable by mechanical mixing of the individual dyes in the desired weight ratio. The individual dyes can be utilized in the form of dye powders or dye solutions or else in the form of formulated commercial forms, say as a powder, granulation or liquid brand, which include customary auxiliaries.

The individual dyes are known or can be obtained in commerce, or prepared in a conventional manner.

The dye mixtures of the present invention are useful for dyeing and printing of hydroxyl-containing materials, particularly cellulosic materials. They are preferably used for dyeing and printing cellulosic fiber materials. The dye mixtures of the present invention, as customary for vat dyes, need to be reduced before they are applied to the substrate to be dyed. Classic chemical lo reducing agents, such as inorganic, for example sulfidic, reducing agents or else organic reducing agents, examples being sodium dithionite and hydroxyacetone, can be used. If desired, however, they can also be applied for dyeing purposes by electrochemical means.

The dye mixtures of the present invention are useful in all dyeing processes in common use for vat dyes, for example in the exhaust process or the pad steam process.

The dye mixtures of the present invention are notable for an excellent build-up, distinctly above the arithmetic mean of the individual components (synergism). A significant improvement provided by the dye mixtures of the present invention compared with prior art products for obtaining red hues also resides in the minimal change in hue after soaping. This feature constitutes an appreciable advantage for using the textiles dyed with the dye mixtures of the present invention.

The examples which follow serve to illustrate the invention.

### EXAMPLE 1

25 parts of C.I. Vat Red 13 and 75 parts of C.I. Vat Red 1, each in the form of a commercially available powder, are mixed and intensively stirred in a suitable vessel.

### EXAMPLES 2 TO 11

Dye mixtures according to the present invention can also be obtained similarly to the method indicated in Example 1 by mixing commercial powders, each already including the requisite auxiliaries, of dyes in the amounts reported in the table which follows.

| | Parts of C.I. Vat Red | | |
|---|---|---|---|
| Examples | 13 | Mix component | Parts |
| 2 | 25 | C.I. Vat Red 1 | 75 |
| 3 | 25 | C.I. Vat Red 10 | 75 |
| 4 | 20 | C.I. Vat Red 14 | 80 |
| 5 | 30 | C.I. Vat Red 15 | 70 |
| 6 | 25 | C.I. Vat Red 23 | 75 |
| 7 | 20 | C.I. Vat Red 32 | 80 |
| 8 | 50 | C.I. Vat Red 23 | 50 |
| 9 | 45 | C.I. Vat Red 10 | 55 |
| 10 | 18 | C.I. Vat Red 32 | 82 |
| 11 | 10 | C.I. Vat Red 23 | 90 |

### EXAMPLE 12

The build-up of the individual dyes C.I. Vat Red 13 and C.I. Vat Red 23 compared with an inventive mixture comprising 25% by weight of C.I. Vat Red 13 and 75% by weight of C.I. Vat Red 23 was determined as follows:

1. Preparation of Dyeings

Dyeings were prepared with the individual dyes C.I. Vat Red 13 and C.I. Vat Red 23 and also the inventive mixture comprising 25% by weight of C.I. Vat Red 13 and 75% by weight of C.I. Vat Red 23 in the concentrations reported in Table 1, i.e., from 0.5% to 9%, all on weight of fiber of the cotton knit to be dyed, by the following general process prescription:

A dyeing receptacle is filled with a dyeing liquor consisting of the reported amounts of dye (individual dye or mixture), 18 ml/l (up to 35 ml/l in the case of dark shades) of 38° Bé caustic soda and 6 g/l (up to 12 gml/l in the case of dark shades) of sodium dithionite as a reducing agent, and the fabric to be dyed, namely cotton knit, at room temperature in a liquor ratio of 20 parts of water to 1 part of fabric. The dyeing receptacle is then sealed and heated to 60° C. at 2° C./min. This temperature of 60° C. is then maintained for 30 min (45 min in the case of dark shades). During this period, the dye dissolved by the reducing agent goes onto the fiber.

This is followed by rinsing with cold water and next by the oxidation. To this end, a treating liquor in a liquor ratio of 50:1 is prepared at 60° C. to include 2 ml/l of hydrogen peroxide 50%. The oxidation takes place during 10 min at these conditions. The final hue of the dyeing is established by the subsequent soaping step. A treating liquor in a liquor ratio of 50:1 is prepared at 98° C. to include 1 g/l of a commercially available soaping agent and 0.5 g/l of sodium carbonate. This treatment is carried out for 20 min. The fabric is subsequently rinsed, hydroextracted and dried.

2. Determination of Color Strength

The depth of shade of each dyeing obtained was determined by colorimetry and represented by the Kubelka-Munk Color Density Unit (CDU) value (see Table 1). The values found for the individual dyes were additionally used to arithmetically calculate the values to be expected for the mixture. Observed and calculated values are given in Table 1:

TABLE 1

| Mix of 25 wt % C.I. Vat Red 13 and | | | | | | | |
|---|---|---|---|---|---|---|---|
| 75 wt % C.I. Vat Red 23 | | | | | | | |
| | | calculated | | C.I. Vat 13 | | C.I. Vat 23 | |
| observed | | | CDU | | CDU | | CDU |
| Conc.(%) | CDU value | Conc. | value | Conc. | value | Conc. | value |
| 0.5 | 0.694 | 0.5 | 0.607 | 0.5 | 0.73 | 0.5 | 0.566 |
| 1 | 1.247 | 1 | 1.091 | 1 | 1.383 | 1 | 0.993 |
| 2 | 2.096 | 2 | 1.839 | 2 | 2.607 | 2 | 1.583 |
| 3 | 2.904 | 3 | 2.359 | 3 | 3.599 | 3 | 1.946 |
| 5 | 3.873 | 5 | 3.109 | 5 | 4.813 | 5 | 2.541 |
| 7 | 4.407 | 7 | 3.530 | 7 | 5.401 | 7 | 2.906 |
| 9 | 4.802 | 9 | 3.803 | 9 | 5.706 | 9 | 3.169 |

The values in Table 1 reveal that the inventive mixture provides distinctly better build-up than arithmetically predicted. There is a surprising synergy for the inventive mixture.

### EXAMPLE 13

The soaping behavior of the inventive dye mixture of Example 12 compared with the individual dyes was determined by the following method:

First, dyeings were prepared in a concentration of 2% in accordance with the to method given in Example 12. On completion of the respective dyeing including the necessary oxidation, the dyeing was rinsed 5 min at a time with hot and then cold water in overflow. The amount of water used for this purpose is not relevant. All that matters is that chemicals no longer needed and unfixed portions of dye are removed. The dyeing is then divided into 3 equal parts. The first part is dried only. The second part is treated for 1 min in a prepared waterbath raised to 98° C. and containing 1 g/l of commercially available laundry detergent. Thereafter, the second part is removed from the treating bath and again rinsed hot and cold in overflow and subsequently dried. The third part is treated like the second part, except that it remains for 20 minutes in the treating bath at 98° C. Subsequently, it is again rinsed hot and cold and dried. After a residence time in a conditioned room of at least 4 hours, the 3 differently treated parts can be subjected to a comparative calorimetric assessment in which the hue difference between the untreated dyeing and the dyeing kept for 1 minute in the treating bath and the hue difference between the untreated dyeing and the dyeing kept for 20 minutes in the treating bath were determined.

Tables 2 and 3 show the coloristic properties of the inventive mixtures compared with the soaping behavior of the individual components as a function of the treatment time between one minute and twenty minutes at 98° C. The dyeing was colorimetrically assessed by color locus measurement in accordance with German standard specifications DIN 6174 and DIN 5033. The dC data in the table describe the change in the brilliance/cleanness and the dH data describe the change in their hue. The decisive improvement resides in the minimal change in hue after soaping, a feature which constitutes a significant advantage for the later use of the textile thus dyed.

Table 2 shows the soaping behavior between non-soaped and 1 minute aftersoaping at 98° C.:

TABLE 2

| | Mix of 25 wt % C.I. Vat Red 13 and | | |
|---|---|---|---|
| | 75 wt % C.I. Vat Red 23 | C.I. Vat 13 | C.I. Vat 23 |
| dC | −1.8 | −2.3 | 0.6 |
| dH | −0.4 | −3.0 | 0.7 |

Table 3 shows the soaping behavior between nonsoaped and 20 minutes aftersoaping at 98° C.

TABLE 3

| | Mix of 25 wt % C.I. Vat Red 13 and | | |
|---|---|---|---|
| | 75 wt % C.I. Vat Red 23 | C.I. Vat 13 | C.I. Vat 23 |
| dC | −0.9 | −1.6 | 0.8 |
| dH | 0.1 | −2.2 | 0.7 |

The decisive improvement resides in the minimal change in hue after soaping, a feature which constitutes a significant advantage for the later use of the textile article thus dyed.

The hue stability due to the mixture of the present invention provides the user with distinctly higher operating consistency. Since hue shifts in the case of vat dyes are irreversible changes in hue, the dye mixture of the present invention also offers the later user of the textile article a decisive advantage.

1-8. (canceled)

9. A dye mixture comprising the dye C.I. Vat Red 13 and at least one dye selected from the group consisting of C.I. Vat Red 1, C.I. Vat Red 10, C.I. Vat Red 14, C.I. Vat Red 15, C.I. Vat Red 23, and C.I. Vat Red 32.

10. The dye mixture of claim 9, comprising C.I. Vat Red 13 and C.I. Vat Red 23.

11. The dye mixture of claim 9, comprising from 5% to 95% by weight of C.I. Vat Red 13 and from 95% to 5% by weight of at least one dye selected from the group consisting of C.I. Vat Red 1, C.I. Vat Red 10, C.I. Vat Red 14, C.I. Vat Red 15, C.I. Vat Red 23, and C.I. Vat Red 32.

12. The dye mixture of claim 9, comprising from 10% to 50% by weight of C.I. Vat Red 13 and from 50% to 90% by weight of at least one dye selected from the group consisting of C.I. Vat Red 1, C.I. Vat Red 10, C.I. Vat Red 14, C.I. Vat Red 15, C.I. Vat Red 23, and C.I. Vat Red 32.

13. The dye mixture of claim 9, comprising from 20% to 30% by weight of C.I. Vat Red 13 and from 80% to 70% by weight of C.I. Vat Red 23.

14. A process for producing the dye mixture of claim 9, comprising mechanically mixing the individual dyes.

15. A dye composition comprising the dye mixture of claim 9.
